(19) United States
(12) Patent Application Publication
(10) Pub. No.: US 2021/0178449 A1
(43) Pub. Date: Jun. 17, 2021

(54) AEROSOL CAN HAVING SURFACE PATTERN ON TRUNK PORTION AND MANUFACTURING METHOD THEREOF

(71) Applicant: DAIWA CAN COMPANY, Chiyoda-ku (JP)

(72) Inventors: Chiharu NABETA, Sagamihara-shi (JP); Hiroyuki OHNO, Sagamihara-shi (JP); Shigeru NOTO, Sagamihara-shi (JP)

(73) Assignee: DAIWA CAN COMPANY, Chiyoda-ku (JP)

(21) Appl. No.: 16/077,206

(22) PCT Filed: Mar. 30, 2018
(86) PCT No.: PCT/JP2018/013551

§ 371 Date: Aug. 10, 2018

(30) Foreign Application Priority Data
Dec. 28, 2017 (JP) 2017-252945

(51) Int. Cl. B21D 51/26; B65D 1/02

(52) U.S. Cl. CPC B21D 51/2607; B65D 83/38; B65D 1/0223

(57) ABSTRACT

An aerosol can body includes a lower opening Ob formed on one end of the seamless cylindrical trunk portion. A domed shoulder portion is formed on the other end of the trunk portion continuously from the trunk portion. An opening curled portion that is diametrically smaller than the lower opening Ob is formed on a center of a leading end of the shoulder portion. The surface pattern is formed on the trunk portion between an upper end of the shoulder portion side and a lower end of the lower opening Ob side. An upper region A that has a predetermined width including an upper end portion of the surface pattern in an axial direction of the trunk portion is formed above the trunk portion. Vickers hardness of at least the upper region a of the trunk portion is greater than 200 Hv but less than 250 Hv.

### TECHNICAL FIELD

The present invention relates to a can body containing pressurized aerosol, and more specifically, to a can body having a patterned surface formed by embossing or debossing a trunk portion, and a manufacturing method thereof.

### BACKGROUND ART

Patent Document 1 describes a two-piece type aerosol metal can. In the metal can, a cylindrical can body is formed by drawing or ironing a steel thin plate such as tin free steel, and a bottom lid is attached to one of open ends (lower end opening) of the can body by a seaming method. The other end of the can body is shaped into a domed shape having an arcuate cross-sectional shape by drawing/ironing method, and an opening curled portion to which a valve is attached is formed at a center peak of the domed portion.

In addition, Patent Document 2 describes an aerosol container having a beaded thin wall. A can trunk of the aerosol container is made of aluminum and is formed integrally with a cylindrical thin wall and a bottom lid. The bottom lid is shaped into a domed shape protruding into the can trunk, and ridges and grooves extending in a height direction of the thin wall are formed alternately on an entire circumference of the thin wall. A canopy having a nozzle is attached to an upper opening of the can trunk.

### PRIOR ART DOCUMENT

### Patent Literature

Patent Document 1: JP 2004-276068 A.

Patent Document 2: JP 2005-538003 A.

### SUMMARY OF INVENTION

### Technical Problem to be Solved by the Invention

If a surface pattern such as an emboss bead is formed on the trunk of the metal can, deformation caused by an internal pressure is less likely to occur as described in Patent Document 2. Therefore, a thickness of the can trunk of the metal can described in Patent Document 1 may be reduced by forming the surface pattern of this kind on the can trunk. However, the container described in the reference 2 is made of aluminum, whereas the metal can described in Patent Document 1 is made of steel. For this reason, a load required to form the surface pattern on the metal can described in Patent Document 1 is significantly larger than that required to form the surface pattern on the container made of soft material such as aluminum.

As described, in the metal can described in Patent Document 1, a so-called shoulder portion is shaped into a domed shape and the cylindrical portion is formed continuously from a lower portion of the shoulder portion, therefore, the surface pattern would be formed on the cylindrical portion. In this case, the surface pattern is formed partially in the upper portion of the cylindrical trunk but the remaining portion of the upper portion of the can trunk is plane. In the container described in Patent Document 2, a bead is formed entirely on the cylindrical thin wall. That is, there is no site where a wall thickness or a cross-sectional shape changes significantly. However, if the surface pattern is formed on the cylindrical portion extending from the domed shoulder portion, a wall thickness or a cross-sectional shape changes significantly at a boundary between the patterned surface and the plane surface. Such boundary may reduce rigidity.

In particular, in the can container described in Patent Document 1 in which diameters of the lower end opening and the curled upper end opening are significantly different, rigidity of a member supporting an inner mold (inner tool) disposed in the can body is reduced at the upper end side than the lower end side. Consequently, a reaction against a load applied to form the surface pattern may be reduced at the upper end side. In order to prevent such disadvantage, any one of an outer mold (outer tool) and the inner mold may be inclined in such a manner that an upper end of the inclined one comes close to the other one thereby forming the surface pattern taking account of deflection due to lack of support rigidity. However, such inclination of the outer mold or the inner mold is set according to load distribution in a condition where a forming load is applied entirely to the can body or the can trunk in the axial direction. Therefore, in the different condition, specifically, at a forming starting point, the forming load would be concentrated on a narrow portion due to the relative inclination between the outer mold and the inner mold. In this case, a machining depth would be increased locally or the can body would be cracked thereby changing a wall thickness or a cross-sectional shape. As a result, buckling strength of the can body or the can trunk may be reduced.

The present invention has been conceived noting the foregoing technical problems, and it is therefore an object of the present invention is to increase a buckling strength of an aerosol can body in which a surface pattern is formed on a cylindrical trunk portion extending from a domed shoulder portion having an arcuate cross-section, and a method for manufacturing such aerosol can.

### Means for Solving the Problem

According to one aspect of the present invention, there is provided an aerosol can body having a surface pattern on a trunk portion, comprising: a lower opening to which a bottom lid is attached, and which is formed on one end of the seamless cylindrical trunk portion formed of a steel sheet; a domed shoulder portion having an arcuate cross-section, that is formed on the other end of the trunk portion continuously from the trunk portion; and an opening curled portion that is diametrically smaller than the lower opening and that is formed on a center of a leading end of the shoulder portion. The surface pattern is formed on the trunk portion between an upper end of the shoulder portion side and a lower end of the lower opening side by deforming the trunk portion in a thickness direction. In order to achieve the above-explained objective, an upper region that has a predetermined width including an upper end portion of the surface pattern in an axial direction of the trunk portion is formed above the trunk portion. In addition, Vickers hardness of at least the upper region of the trunk portion is greater than 200 Hv but less than 250 Hv.

According to the present invention, a hardness of the upper region may be work hardened to be harder than a portion of the trunk portion below the upper region, and Vickers hardness of the upper region may be greater than 200 Hv but less than 250 Hv.

According to the present invention, Vickers hardness of the upper region may be increased harder than Vickers hardness of the portion of the trunk portion below the upper region, by setting a wall thickness of the upper region thicker than 0.18 mm but thinner than 0.28 mm, setting a wall thickness of the portion of the trunk portion below the upper region thicker than 0.16 mm but thinner than 0.22 mm, and the wall thickness of the upper region is set thicker than the wall thickness of the portion of the trunk portion below the upper region.

According to the present invention, a buckling strength of the can body in which the bottom lid is attached to the lower opening may be greater than 1700 N but less than 2500 N.

According to another aspect of the present invention, there is provides a manufacturing method of an aerosol can body having a surface pattern on a trunk portion, in which the surface pattern is formed on the trunk portion formed of a steel sheet and a bottom lid is attached to a lower opening of the trunk portion, in which a domed shoulder portion having an arcuate cross-section is formed continuously from an upper end of the trunk portion, and in which an opening curled portion that is diametrically smaller than the lower opening is formed on a center of a leading end of the shoulder portion. The manufacturing method comprises: setting a portion of predetermined width of the trunk portion including an upper end of the surface pattern as an upper region; setting Vickers hardness of at least the upper region of the trunk portion greater than 200 Hv but less than 250 Hv by shaping the trunk portion into a cylindrical shape by ironing; forming the shoulder portion continuously from the upper end of the trunk portion; forming the opening curled portion on the center of the leading end of the shoulder portion; and mounting the can body in which the shoulder portion and the opening curled portion have been formed on an inner tool, and forming the surface pattern by pushing the trunk portion onto a surface of an outer tool that is inclined such that an upper end portion of the outer tool comes close to the inner tool, while rolling the trunk portion on the surface of the outer tool.

According to the present invention, Vickers hardness of the upper region may be set greater than 200 Hv but less than 250 Hv, by increasing a work hardness of the upper region harder than a work hardness of the portion below the upper region, or increasing a wall thickness of the upper region thicker than a wall thickness of the portion below the upper region.

According to the present invention, an upper end portion of the inner tool may be supported by a support rod falling from above the inner tool on which the can body is mounted to come into contact to the upper end portion of the inner tool though the opening curled portion.

### Advantageous Effects of Invention

Thus, according to the present invention, relative positions of molds or tools are set such that the molds or tools are brought into correct postures after starting forming of the surface pattern taking account of deformation or displacement of the molds or tools caused by a forming load. Therefore, the forming load is concentrated to a specific point in an initial phase and a final phase of forming of the surface pattern. However, the forming load is concentrated to the point in the upper region, and Vickers hardness of the upper region is set greater than 200 Hv but less than 250 Hv. For this reason, the can trunk will not be processed excessively at the specific point. The surface pattern may be effective to enhance a so-called “panel strength”, but may be disadvantageous in terms of a buckling strength. However, according to the present invention, the surface pattern will not be processed excessively to be deformed. For this reason, the buckling strength of the can body may be maintained to a desired value. According to the present invention, therefore, the can body may be thinned and lightened without reducing the panel strength and the buckling strength.

### BRIEF DESCRIPTION OF DRAWINGS

FIG. 1 is a partially broken front view showing one example of a can body according to the present invention.

FIG. 2 is a schematic illustration showing steps of manufacturing the can body by drawing and ironing.

FIG. 3 is a process chart showing steps of forming a shoulder portion.

FIG. 4 is a schematic illustration schematically showing a profile of a punch.

FIG. 5 is a perspective view schematically showing structures of an inner tool and an outer tool.

FIG. 6 is a partial view showing arrangements of the inner tool and the outer tool.

FIG. 7 is a schematic illustration showing the outer tool inclined toward the inner tool.

### DESCRIPTION OF EMBODIMENT(S)

The present invention relates to a can body containing aerosol. An internal pressure of the can body containing aerosol is high, and hence a strength of the can body has to be high enough to receive a load perpendicular to a peripheral wall. In addition, in order to receive a load applied to the can body in a height direction during manufacturing or transportation, or when attaching a valve to the can body or filling the can body with contents, a strength of the can body has to be high enough also in the height direction. Further, as the conventional cans, the can body has to have a good appearance.

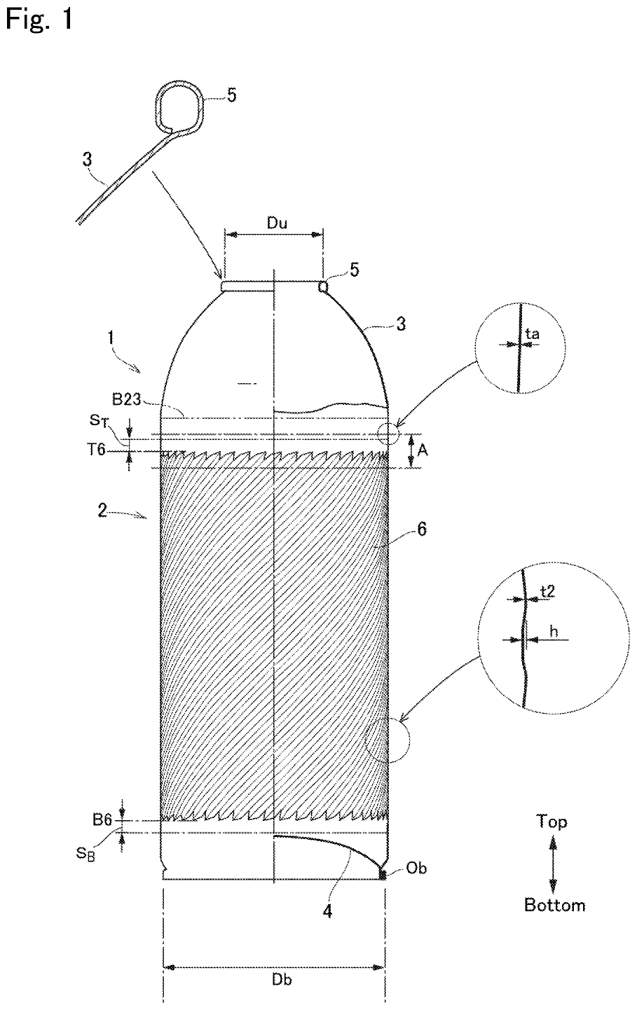

One example of the can body 1 according to the present invention is shown in FIG. 1. Specifically, FIG. 1 shows the can body 1 in which a nozzle and a valve for spraying aerosol have not yet attached thereto. The can body 1 is a two-piece type can body formed by processing a steel sheet. For example, a tin-plated steel sheet, an extremely thin tin-plated steel sheet, a nickel-plated steel sheet, an electrolytic chromate-treated steel sheet, a zinc-plated steel sheet or the like may be used as a material of the can body 1. Instead, a metallic sheet in which both faces are coated by thermoplastic resin films may also be used to form the can body 1. Material of the resin film is not limited to the specific resin, and the resin film may be formed of two or more layers of different resins. For example, a polyester resin, a polycarbonate resin, a nylon resin, a mixture of two or more kinds of those resins may be used to cover the metallic sheet. Specifically, the polyester resin can be exemplified by: a copolymer of polyethylene, polypropylene, and ethylene-propylene; an olefin resin such as modified olefin; a copolymer of polyethylene terephthalate, polybutylene terephthalate, polyethylene naphthalate, ethylene terephthalate-isophthalate; a copolymer of ethylene terephthalate-adipate; a copolymer of butylene terephthalate-isophthalate; and a coplymer of ethylene naphthalate-terephthalate. An inner surface and an outer surface of the can body 1 may also be painted. For example, painting materials described in Japanese Patent Laid-Open No. H4-11974 may be used. Specifically, the inner surface may be painted by epoxy-phenol material, and clear polyester material may be used as an overcoat of a printed layer of the outer surface.

The can body 1 comprises a cylindrical trunk portion 2 and a shoulder portion 3 formed continuously from an upper end of the trunk portion 2. The shoulder portion 3 is shaped into domed shape having an arcuate cross-section. That is, the cylindrical trunk portion 2 is situated below a boundary B23 at which a curvature is changed toward the domed shoulder portion 3. A bottom lid 4 as a thin plate member is attached to an opening of lower end of the trunk portion 2. The bottom lid 4 is manufactured separately from the can body 1 using the same material as the can body 1, and curved upwardly to protrude into an internal space of the trunk portion 2. Specifically, a circumferential edge of the bottom lid 4 is seamed to a lower opening Ob of the trunk portion 2.

An opening curled portion 5 is formed on a center of a leading end (upper end) of the shoulder portion (domed portion). As illustrated in an enlarged scale in FIG. 1, the opening curled portion 5 is formed by curling a cut end outwardly, and a not shown valve member or the like is attached thereto. An inner diameter or an outer diameter Du of the opening curled portion 5 is approximately one-half of an inner diameter or outer diameter of the trunk portion 2, or an inner diameter or an outer diameter Db of the lower opening Ob.

A surface pattern 6 is formed entirely on an outer periphery of the trunk portion 2. The surface pattern 6 is formed by embossing or debossing the trunk portion 2 in a thickness direction to form ridges and grooves. In the example shown in FIG. 1, helical ridges or grooves are formed. A height of the ridge or a depth of the groove (to be referred to as the height hereinafter) h is approximately 0.07 mm to 0.23 mm. According to the present invention, the surface pattern 6 may also be formed into a grid pattern, a lattice pattern, a hexagonal pattern etc.

An upper end level T6 of the surface pattern 6 is set slightly lower than the boundary B23 between the trunk portion 2 and the shoulder portion 3, and a strength of a predetermined region (as will be referred to as the upper region hereinafter) A including the upper end level T6 in the height direction of the trunk portion 2 is greater than that of the remaining portion. For example, a wall thickness ta of the upper region A is thicker than a wall thickness t2 of an intermediate portion of the trunk portion 2 below the upper region A. Specifically, the wall thickness ta of the upper region A is 0.2 mm to 0.28 mm, whereas the wall thickness t2 of the intermediate portion of the trunk portion 2 is 0.19 mm. Each of those thicknesses is a net thickness of the metallic sheet, and increased by thicknesses of the resin layers (approximately 20 μm) covering the inner and outer surfaces. A width (in the height direction of the trunk portion 2) of the upper region A is 1 mm to 20 mm (preferably 3 mm to 20 mm). If it is narrower than 1 mm, rigidity or hardness may not fall within a desired range, and if it is wider than 20 mm, such effect is no longer expected.

A straight portion ST is formed above the upper end level T6 of the surface pattern 6, and a straight portion SB is formed below a lower end level B6 of the surface pattern 6. Each of those straight portions ST and SB is a part of the trunk portion 2, and an outer diameter of each of the straight portion ST and SB is substantially constant. For example, a width (in the height direction of the trunk portion 2) of each of the straight portion ST and SB is wider than 5 mm. Specifically, the upper straight portion ST is formed between the upper end level T6 of the surface pattern 6 and the boundary B23. By thus forming the straight portions ST and SB, the trunk portion 2 (especially a portion on which the surface pattern 6 is applied) can be held by clamping the straight portions ST and SB when embossing or debossing the trunk portion 2 to form the surface pattern 6. Consequently, the trunk portion 2 is allowed to be processed as intended without being deformed.

The can body 1 is a seamless can formed by drawing and ironing the metallic sheet. Rigidity or stiffness of the can body 1 is adjusted by adjusting the wall thickness and work-hardness during processing. According to the embodiment, Vickers hardness of at least the upper region A of the trunk portion 2 is set to 200 to 250 Hv (greater than 200 Hv but less than 250 Hv). According to the present invention, Vickers hardness of entire trunk portion 2 may be set to 200 to 250 Hv. However, although Vickers hardness of the upper region A is set to 200 to 250 Hv, a portion below the upper region A may be set e.g., to 190 to 240 Hv (greater than 190 Hv but less than 240 Hv). Vickers hardness of the trunk portion 2 may also be adjusted within the above explained ranges by adjusting the wall thickness ta thereby differentiating Vickers hardness of the portion below the upper region A from Vickers hardness of the upper region A. Specifically, the wall thickness ta of the upper region A may be kept thicker than that of the portion below the upper region A by adjusting the drawing and the ironing. The above-explained wall thickness and hardness are thickness and hardness before forming the surface pattern 6 after drawing and ironing.

In the can body 1 according to the embodiment of the present invention, although the wall thickness and hardness of the upper region A may be differentiated from those of the remaining portion, a height or a depth of the surface pattern 6 is substantially constant. For this reason, strength (panel strength) against a load applied perpendicular to the trunk portion 2 is increased. In addition, since the height or the depth of the surface pattern 6 is homogenized, points to cause buckling distortion can be eliminated to increase buckling strength.

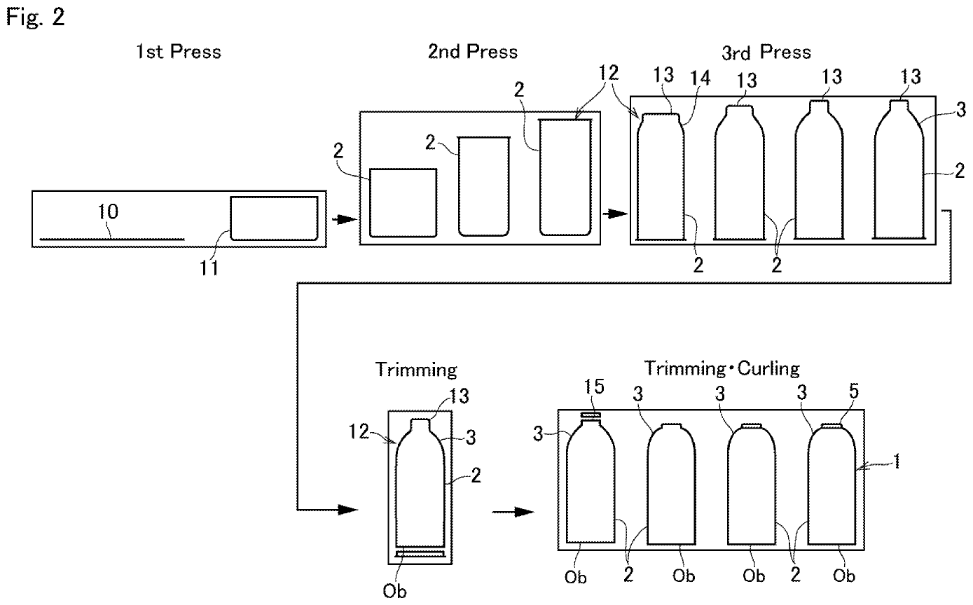

Here will be explained a manufacturing method of the can body 1. As will be explained hereinafter, the can body 1 may be formed basically by the manufacturing method described in the above explained Japanese Patent Laid-Open No. 2004-276068. FIG. 2 schematically shows steps for manufacturing the can body 1. The can body 1 is formed from a metallic sheet prepared by forming a thermoplastic resin coating layer on both surfaces of a surface-treated steel sheet, and lubricant is applied to both surfaces of the metallic sheet (to the resin coating layers). First of all, a blank 10 is punched out of the metallic sheet. At cup shaping step (1st press), the blank 10 is shaped into a cup 11 by a drawing treatment. Then, at can trunk shaping step (2nd press), a thinning treatment such as drawing and ironing is applied to the cup 11. Instead, at least one or more times of re-drawing, and stretching or ironing may also be applied to the cup 11. Consequently, a bottomed-cylindrical seamless can 12 in which the trunk portion 2 is thinned is formed. Specifically, the seamless can 12 has a vertically long shape in which one of end portions of the trunk portion opens. According to the embodiment of the present invention, the portion corresponding to the upper region A of a closed end side is thickened to have greater hardness than the remaining portion by ironing or drawing.

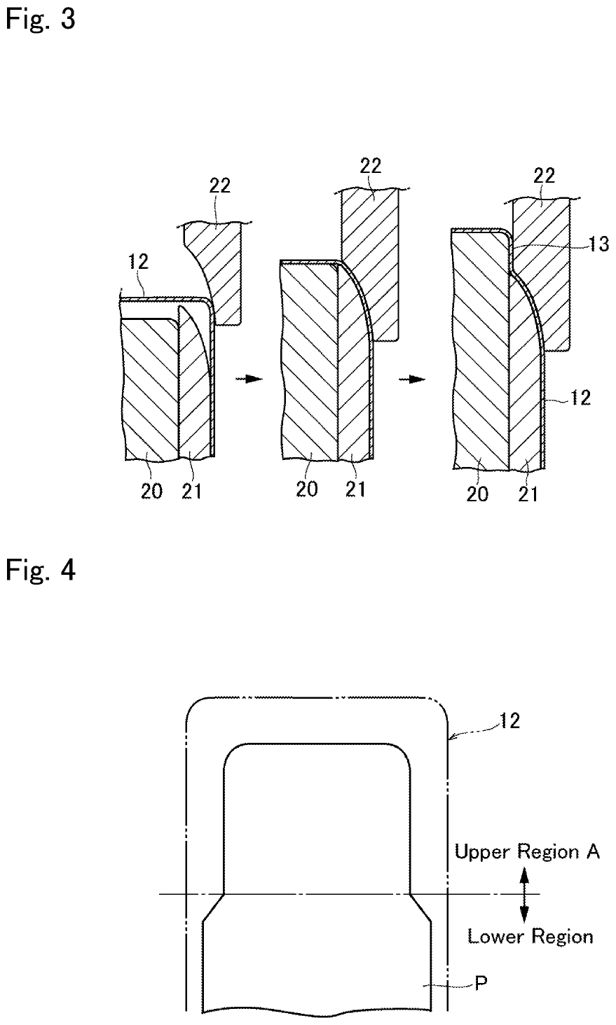

Thereafter, at top dome shaping step (3rd press), a closed bottom portion of the seamless can 12 is shaped into a bottomed-cylindrical portion 13 that is diametrically smaller than the trunk portion 2 by a first drawing step, and a curved shoulder face 14 whose longitudinal section is arcuate is also formed by the first drawing step. Then, a diameter of the bottomed-cylindrical portion 13 is further reduced and the bottomed-cylindrical portion 13 is elongated by a second drawing (re-drawing). At this step, a tapered face having a substantially straight longitudinal section approximating a tangential line drawn to an arcuate longitudinal section of a virtual curved face leading to the curved shoulder face 14 is re-drawn, and such re-drawing is executed repeatedly. Then, a plurality of tapered faces of the shoulder portion 3 approximated to the curved shoulder face 14 is pressed to be extended into a smooth curved face leading to the curved shoulder face 14. Consequently, the shoulder portion 3 is entirely shaped into a smooth domed face, and the portion corresponding to the upper region A is thickened to have greater hardness than the remaining portion by ironing or drawing. A method of shaping the shoulder portion 3 entirely into a domed shape is also described in Japanese Patent Laid-Open No. 2004-276068. Such method will be briefly explained with reference to FIG. 3.

As illustrated in FIG. 3, a punch 20 is inserted into a pusher 21, and the seamless can 12 is mounted on the pusher 21 in such a manner that the bottom portion is situated at an upper side. The pusher 21 is a tool for unwrinkling the seamless can 12 in cooperation with a die 22. Specifically, the pusher 21 has a convex curve on its upper end portion, and the die 22 has a concave curve corresponding to the convex curve of the pusher 21 on its lower end portion. A corner portion of the seamless can 12 is clamped by the pusher 21 and the die 22 to be unwrinkled, and the flat bottom portion of the seamless can 12 is redrawn into the bottomed-cylindrical portion 13 by the punch 20. Thus, the bottomed-cylindrical portion 13 that is diametrically smaller than the trunk portion 2 of the seamless can 12 and the curved shoulder face whose longitudinal section is arcuate are formed by the first drawing step. The opening curled portion 5 is formed by trimming the center portion of the leading end of the shoulder portion 3. However, if it is difficult to reduce the diameter of the bottomed-cylindrical portion 13 to a diameter of the opening curled portion 5 by a single step shown in FIG. 3, the bottomed-cylindrical portion 13 is further drawn using a punch, a pusher, and a die whose diameters are respectively smaller than those of the punch 20, the pusher 21, and the die 22. Thus, the shoulder portion 3 and the bottomed-cylindrical portion 13 having the opening curled portion 5 are formed by drawing the seamless can 12 one or more times. Further, the shoulder portion is reformed by a not shown pusher and a die respectively having a virtual curved face corresponding to a desired domed shape.

As a result of such drawing step(s), the trunk portion 2 is work hardened. At this step, Vickers hardness of entire trunk portion 2 may be set to 200 to 250 Hv by adjusting a drawing rate. In order to differentiate the hardness and the wall thickness of the upper region A from those of the portion below the upper region A, a shape of a portion of the punch corresponding to the upper region A may be differentiated from a shape of a portion of the punch corresponding to the portion below the upper region A. For example, as a profile schematically illustrated in FIG. 4, an outer diameter of the portion of the punch P corresponding to the upper region A may be reduced, and an outer diameter of the portion of the punch P below the upper region A may be increased. Preferably, such difference between the diameters falls within a range between 0.1 mm and 0.4 mm (more preferably, greater than 0.12 mm but smaller than 0.36 mm), and a portion at which the diameter changes is curved or tapered smoothly.

After shaping the shoulder portion 3 into a domed face and reducing the diameter of the bottomed-cylindrical portion 13 to a desired value, the lower opening Ob of the trunk portion 2 of the seamless can 12 is trimmed to realize a constant height. Then, at trimming/curling step, the leading end of the bottomed-cylindrical portion 13 is trimmed and opened. An opening end 15 is curled outwardly to form the opening curled portion 5. Thereafter, the bottom lid 4 is attached by the method described in Japanese Patent Laid-Open No. 2004-276068.

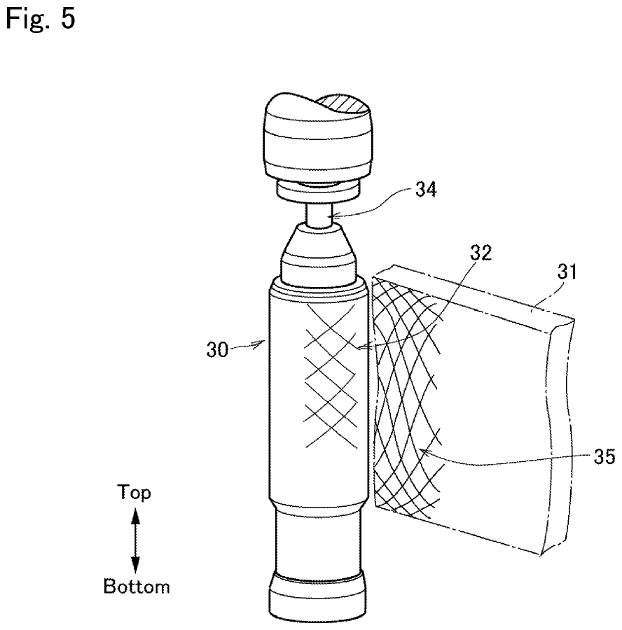

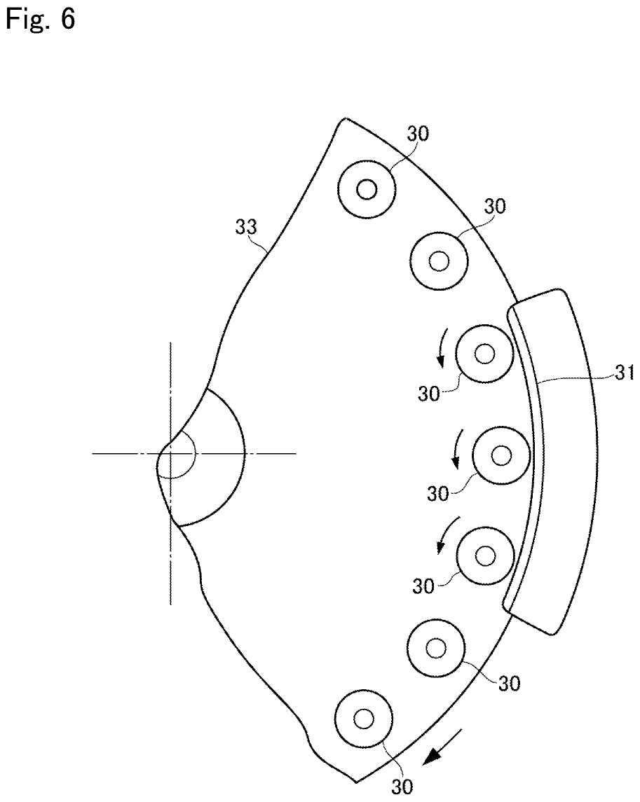

According to the embodiment of the present invention, the surface pattern 6 is formed by embossing, debossing, or beading the trunk portion 2 of the can body 1. A structure of a forming tool is schematically shown in FIGS. 5 and 6. The forming tool comprises an inner tool 30 as a male die, and an outer tool 31 as a female die. The inner tool 30 is a cylindrical member that is inserted into the can body 1 to which the bottom lid 4 has not yet been attached, from the lower opening Ob. In other words, the can body 1 is mounted on the inner tool 30 from above. Specifically, an outer diameter of the inner tool 30 is slightly smaller than an inner diameter of the trunk portion 2, and a pattern 32 for forming a desired pattern on the trunk portion 2 is formed on an outer circumferential face. The inner tools 30 are held upright in a circumferential portion of a turntable 33 at regular intervals while being allowed to rotate. Although not especially shown, the inner tool 30 revolves around a rotational center axis of the turntable 33 while rotating around a center axis thereof with a rotation of the turntable 33. In order to allow the inner tool 30 to rotate, for example, a gear may be arranged coaxially with the inner tool 30, and a fixed gear may be arranged in an outer circumferential side of an orbit of the gear. Those gears are meshed with each other so that the inner tool 30 is rotated with a rotation of the gear arranged coaxially with the inner tool 30.

As described, the can body 1 is mounted on the inner tool 30, therefore, an upper end portion of the inner tool 30 is a free end that is not supported. However, a load is applied to the inner tool 30 from the side to form the surface pattern 6, therefore, a bending load would be increased excessively if the upper end portion of the inner tool 30 is a free end. For this reason, each of the inner tools 30 is provided individually with a support rod 34 arranged at the upper end. The support rod 34 is allowed to rotate synchronously with the inner tool 30 and to reciprocate vertically. A diameter of the support rod 34 is set to a value possible to be inserted into the opening curled portion 5 of the can body 1, and bending stiffness of the support rod 34 is significantly lower than that of the inner tool 30. Specifically, the support rod 34 falls from above the inner tool 30 on which the can body 1 is mounted, and comes into contact to an upper end of the inner tool 30 though the opening curled portion 5 thereby supporting the upper end of the inner tool 30. The inner tool 30 and the support rod 34 are rotated at a high speed, therefore, those members are merely contacted to each other. That is, the inner tool 30 and the support rod 34 are not integrated completely at least in the lateral direction, and slightly deformed by a load to form the surface pattern 6 (in a direction away from the outer tool 31).

The outer tool 31 is a plate forming tool having an arcuate surface on which a pattern 35 paired with the pattern 32 formed on the surface of the inner tool 30. The outer tool 31 is fixed in such a manner that the arcuate surface on which the pattern 35 is formed is situated along an orbit of an outer circumferential face of the can body 1 mounted on the inner tool 30 to be revolved. A clearance between the inner tool 30 and the outer tool 31 is set in such a manner that the patterns 32 and 35 are engaged with each other through the trunk portion 2. Thus, the surface pattern 6 is debossed or embossed by rolling the can body 1 mounted on the inner tool 30 on the arcuate surface of the outer tool 31, and consequently the surface pattern 6 is formed on the trunk portion 2 by the patterns 32 and 35.

As described, the can body 1 is made of a steel sheet, and a wall thickness of the trunk portion 2 is approximately 0.2 mm and the height h of the surface pattern 6 is approximately 0.2 mm. Therefore, a forming load greater than 3000 N is required, whereas a forming load required to form a surface pattern on a can body made of aluminum is less than 1000 N. Since the outer tool 31 is fixed at an outer circumferential side of the turntable 33, support stiffness and strength of the outer tool 31 may be increased sufficiently. By contrast, the inner tool 30 is held in the turntable 33 in a rotatable manner and the upper end of the inner tool 30 is a free end. Therefore, support stiffness and strength of the inner tool 30 may not be increased significantly, and hence the support stiffness and the strength of the inner tool 30 may be lower than those of the outer tool 31. For this reason, if the inner tool 30 and the outer tool 31 are arranged parallel to each other to form the surface pattern 6 on the can body mounted on the inner tool 30, the upper end of the inner tool 30 may be deformed in the direction away from the outer tool 31 as a result of forming the surface pattern 6. Consequently, the height h of the surface pattern 6 may be lower at the upper end side of the trunk portion 2 than those at the intermediate portion and the lower end portion. In other word, a depth of the formed surface pattern 6 may be shallower.

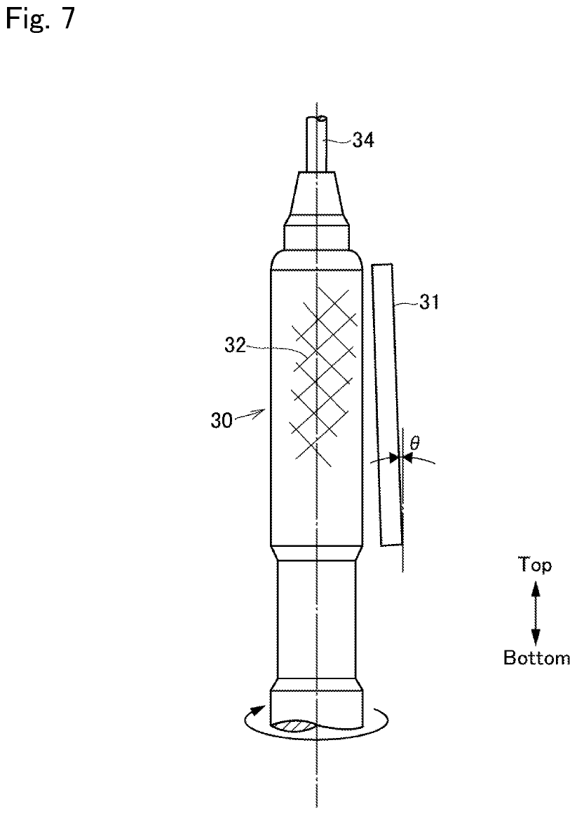

In order to solve such disadvantage to homogenize the height of the surface pattern 6 entirely, according to the embodiment of the present invention, the upper end portion of the outer tool 31 is inclined at predetermined angle θ toward the inner tool 30 taking account of the above-explained deformation or deflection of the inner tool 30, and the surface pattern 6 is formed by the outer tool 31 thus inclined. FIG. 7 schematically shows the inclined outer tool 31. When the inner tool 30 on which the can body 1 is mounted reaches a region where the outer tool 31 is arranged, the inner tool 30 is pushed onto the outer tool 31 and the patterns 32 and 35 are engaged with each other through the trunk portion 2 of the can body 1. Consequently, the surface pattern 6 is formed on the trunk portion 2 by the patterns 32 and 35. In this case, the bending stiffness or the support stiffness of the inner tool 30 is low, and the support rod 34 does not restrict bending deformation of the inner tool 30 completely. Therefore, the inner tool 30 is slightly deformed. However, since the outer tool 31 is inclined taking account of such bending deformation of the inner tool 30, the inner tool 30 is brought into parallel to the outer tool 31 when the forming process is started. As a result, the height h of the surface pattern 6 is homogenized entirely.

Since the outer tool 31 is thus inclined, an upper portion of the inner tool 30 starts engaging with an upper portion of the outer tool 31, and the forming load is concentrated temporarily to the contact point between the inner tool 30 and the outer tool 31. According to the embodiment of the present invention, however, Vickers hardness of at least the upper region A of the trunk portion 2 is set to 200 to 250 Hv. Therefore, a depth (i.e., a height h) of the formed surface pattern 6 will not be increased excessively and a crack will not be generated at a starting point to form the surface pattern 6 (i.e., at a starting point of engagement between the inner tool 30 and the outer tool 31). For this reason, a buckling strength of the can body 1 may fall within a desired range.

Especially, by increasing the hardness of the upper region A harder than those of the intermediate portion and the lower portion of the trunk portion 2 of the can body 1, the height h of the formed surface pattern 6 can be further homogenized, and a difference between the height h at the portion above the trunk portion 2 and the height h of the portion below the trunk portion 2 can be reduced. Thus, the surface pattern 6 is formed by rolling the can body 1 mounted on the inner tool 30 on the surface of the outer tool 31, and the inner tool 30 is deformed to be brought into parallel to the outer tool 31 by the forming load after starting the forming of the surface pattern 6. That is, the inner tool 30 and the outer tool 31 are not parallel to each other in the initial phase of the forming of the surface pattern 6 in which the forming load is not applied to the inner tool 30 entirely. Likewise, an area of the outer tool 31 pushing the inner tool 30 is reduced gradually in a final phase of forming. Therefore, when the can body 1 mounted on the inner tool 30 reaches the region where the outer tool 31 is arranged, and when the can body 1 leaves from the outer tool 31, the upper portion of the trunk portion 2 (above the upper region A) is clamped between the upper portions of the inner tool 30 and the outer tool 31 where the clearance therebetween is narrowest. That is, the forming load is concentrated to an extremely narrow region in the upper region A.

By thus inclining the outer tool 31, the forming load is increased locally in the initial phase and the final phase of forming of the surface pattern 6. Specifically, such increased forming load is applied to the portion in the upper region A which is thickened or work hardened. Therefore, a depth (i.e., a height h) of the formed surface pattern 6 will not be increased locally and a crack will not be generated by the forming load increased locally. For this reason, the height h of the surface pattern 6 is homogenized entirely.

By embossing or beading a portion where a wall thickness is thin such as the trunk portion 2 of the can body 1 to form the surface pattern, a hardness or strength of the processed site against a load applied perpendicular thereto is increased. However, the load perpendicular to the surface pattern, in other words, the load parallel to the center axis of the trunk portion 2 (i.e., the buckling load) is applied to the surface pattern in the direction to narrow the ridge or the groove of the surface pattern. Therefore, if a height or a depth of the surface pattern is locally high or deep, or if the surface pattern is locally thin, stiffness or hardness against the buckling load is reduced. According to the can body 1 or the above-explained manufacturing method of the embodiment, the height h of the surface pattern 6 is homogenized, and the portion where the height h is locally high or the thickness is locally thin does not exist. Therefore, appearance of the can body 1 can be improved. In addition, strength of the can body 1 against the load applied perpendicular to the trunk portion (i.e., a panel strength), and buckling strength of the can body 1 can be enhanced.

Here will be explained specific examples of the can body according to the present invention. In the examples, a plurality of the can bodies according to the present invention and a plurality of can bodies as comparison examples were prepared using a TFS (tin-free steel) sheet whose thickness was 0.25 mm, and buckling strength of those can bodies were measured respectively. Those can bodies were manufactured by the method explained with reference to FIG. 2, and the surface pattern was applied to each of the can bodies by the tools explained with reference to FIGS. 5 to 7. In order to measure Vickers hardness Hv of the can body, a test piece of predetermined size was cut out of each of the can bodies. An indenter was pushed onto the test piece by a load of 245 Newton to apply a Vickers indentation to a predetermined site of the test piece in the thickness direction. The Vickers hardness was measured at ten points in the Vickers indentation, and an average value of the Vickers indentation was employed as the Vickers hardness. The Vickers hardness of the can bodies of the below-explained examples and comparative examples were measured by the same procedure.

### Example 1

Height: 170 mm and 220 mm. Diameter of the trunk portion: 66 mm. Curvature radius of the shoulder portion: 40 to 60 mm. Wall thickness of the trunk portion (to which the surface pattern is applied): 0.18 to 0.23 mm. Ironing rate of Drawing/Ironing: 14 to 50%. Ratio of the surface pattern to an entire surface: 20 to 90%. Height of the formed surface pattern: 0.1 to 0.2 mm. Forming load: 3 KN. Vickers hardness of the work-hardened trunk portion before embossing: 200 Hv.

Ten pieces of can bodies having above-mentioned specifications were prepared, and strengths thereof were measured. The strengths of all of the can bodies fell within the following ranges.
Panel Strength: pressure of 17 to 25 inches of mercury (in/Hg).
Pressure Capacity: buckle 250 to 320 psi, burst 310 to 330 psi.
Buckling Strength: 1700 to 2500 N.
   Specifically, the panel strength is a vacuum pressure level at which the can body is deformed inwardly by reducing an internal pressure, the buckle pressure capacity is a pressure level at which the can body is expanded by increasing the internal pressure, the burst pressure capacity is a pressure level at which the can body is burst by increasing the internal pressure, and the buckling strength is a magnitude of a load at which the can body to which the bottom lid is attached is deformed by applying a load in the axial direction.

### Example 2

Vickers hardness of the work-hardened trunk portion before embossing: 250 Hv. Forming Load: 5 KN. The remaining conditions were identical to those of the example 1.

Ten pieces of can bodies having above-mentioned specifications were prepared, and strengths thereof were measured. The strengths of all of the can bodies fell within the following ranges.
Panel Strength: pressure of 19 to 7 inches of mercury (in/Hg).
Pressure Capacity: buckle 270 to 330 psi, burst 330 to 340 psi.
Buckling Strength: 1700 to 2500 N.

### Example 3

Vickers hardness of an upper region of the work-hardened trunk portion: 200 to 250 Hv. Vickers hardness of a lower region of the work-hardened trunk portion: 190 to 240 Hv. The remaining conditions were identical to those of the example 1.

Ten pieces of can bodies having above-mentioned specifications were prepared, and strengths thereof were measured. The strengths of all of the can bodies fall within the above-mentioned ranges of the example 1.
Remarks: Although the Vickers hardness of the upper region and the lower region of the trunk portion were differentiated, a height of the surface pattern fell within a height range of the surface pattern formed on the can body of the example 1. Appearance and slip resistance were comparable to those of the can body of the example 1.

### Example 4

Wall thickness of the upper region of the trunk portion: 0.18 to 0.28 mm. Wall thickness of the lower region of the trunk portion: 0.16 to 0.22 mm. The remaining conditions were identical to those of the example 1.

Ten pieces of can bodies having above-mentioned specifications were prepared, and strengths thereof were measured. The strengths of all of the can bodies fall within the above-mentioned ranges of the example 1.

### Comparative Example 1

Vickers hardness of the trunk portion before embossing: 190 Hv. The remaining conditions were identical to those of the example 1.

Ten pieces of can bodies having above-mentioned specifications were prepared, and strengths thereof were measured.
Panel Strength: pressure of 15 to 22 inches of mercury (in/Hg).
Pressure Capacity: buckle 230 to 300 psi, burst 290 to 310 psi.
Buckling Strength: 1100 to 2000 N.
Remarks: Three can bodies whose buckling strengths were greater than 1700 N were found. However, the buckling strengths of more than half of the can bodies, i.e., seven can bodies fell within a range between 1100 N and 1600 N. That is, strengths of those can bodies were insufficient. Specifically, in each of those can bodies, a predetermined circumferential region from the upper end of the surface pattern was deformed in the axial direction (i.e., in the height direction).

### Comparative Example 2

Vickers hardness of the trunk portion before embossing: 260 Hv. The remaining conditions were identical to those of the example 2 except for the height of the formed surface pattern.

The strengths were as follows:
Panel Strength: pressure of 17 to 25 inches of mercury (in/Hg).
Pressure Capacity: buckle 260 to 330 psi, burst 310 to 340 psi.
Buckling Strength: 1800 to 2600 N.
Remarks: Heights of the surface patterns were varied between 0.07 and 0.1 mm. The surface pattern was not formed properly to achieve a desired appearance, and slip resistance when grabbed by hand was insufficient.

Based on the results of the examples 1 to 4 and the comparative examples 1 and 2, according to the present invention, the Vickers hardness of the trunk portion or the Vickers hardness of at least the above-mentioned upper region is set within a range between 200 and 250 Hv.

As described, according to the present invention, the outer tool 31 is inclined, and hence the forming load is increased locally in the initial phase and the final phase of the forming process of the surface pattern 6. According to the present invention, however, hardness or wall thickness of the upper region A to which the increased forming load is locally applied is increased greater than that of the remaining portion. Therefore, the buckling strength is increased sufficiently. This is because the upper portion of the surface pattern 6 will not be processed excessively in the initial phase and the final phase of the forming process.

Although the above exemplary embodiments of the present invention have been described, it will be understood that the present invention should not be limited to the described exemplary embodiments, and various modifications of the feature that is not claimed can be made. A can body and a manufacturing method comprising the modified feature is also included in the technical scope of the present invention.

### REFERENCE SIGNS LIST

1: can body; 2: trunk portion: 3; shoulder portion; 4: bottom lid; 5: opening curled portion; 6: surface pattern; 20: inner tool; 21: outer tool; A: upper region; h: height; Ob: lower opening; ta, t2: wall thickness.

1. An aerosol can body having a surface pattern on a trunk portion, comprising:
a lower opening to which a bottom lid is attached, and which is formed on one end of the seamless cylindrical trunk portion formed of a steel sheet;
a domed shoulder portion having an arcuate cross-section, that is formed on the other end of the trunk portion continuously from the trunk portion; and
an opening curled portion that is diametrically smaller than the lower opening and that is formed on a center of a leading end of the shoulder portion,
wherein the surface pattern is formed on the trunk portion between an upper end of the shoulder portion side and a lower end of the lower opening side by deforming the trunk portion in a thickness direction,
an upper region that has a predetermined width including an upper end portion of the surface pattern in an axial direction of the trunk portion is formed above the trunk portion, and
Vickers hardness of at least the upper region of the trunk portion is greater than 200 Hv but less than 250 Hv.

2. The aerosol can body having the surface pattern on the trunk portion as claimed in claim 1,
wherein a hardness of the upper region is work hardened to be harder than a portion of the trunk portion below the upper region, and Vickers hardness of the upper region is greater than 200 Hv but less than 250 Hv.

3. The aerosol can body having the surface pattern on the trunk portion as claimed in claim 2,
wherein Vickers hardness of the upper region is increased harder than Vickers hardness of the portion of the trunk portion below the upper region, by setting a wall thickness of the upper region thicker than 0.18 mm but thinner than 0.28 mm, setting a wall thickness of the portion of the trunk portion below the upper region thicker than 0.16 mm but thinner than 0.22 mm, and the wall thickness of the upper region is set thicker than the wall thickness of the portion of the trunk portion below the upper region.

4. The aerosol can body having the surface pattern on the trunk portion as claimed in claim 1,
wherein a buckling strength of the can body in which the bottom lid is attached to the lower opening is greater than 1700 N but less than 2500 N.

5. A manufacturing method of an aerosol can body having a surface pattern on a trunk portion, in which the surface pattern is formed on the trunk portion formed of a steel sheet and a bottom lid is attached to a lower opening of the trunk portion, in which a domed shoulder portion having an arcuate cross-section is formed continuously from an upper end of the trunk portion, and in which an opening curled portion that is diametrically smaller than the lower opening is formed on a center of a leading end of the shoulder portion, comprising:
setting a portion of predetermined width of the trunk portion including an upper end of the surface pattern as an upper region;
setting Vickers hardness of at least the upper region of the trunk portion greater than 200 Hv but less than 250 Hv by shaping the trunk portion into a cylindrical shape by ironing;
forming the shoulder portion continuously from the upper end of the trunk portion;
forming the opening curled portion on the center of the leading end of the shoulder portion; and
mounting the can body in which the shoulder portion and the opening curled portion have been formed on an inner tool, and forming the surface pattern by pushing the trunk portion onto a surface of an outer tool that is inclined such that an upper end portion of the outer tool comes close to the inner tool, while rolling the trunk portion on the surface of the outer tool.

6. The manufacturing method of the aerosol can body having the surface pattern on the trunk portion as claimed in claim 5,
wherein Vickers hardness of the upper region is set greater than 200 Hv but less than 250 Hv, by increasing a work hardness of the upper region harder than a work hardness of the portion below the upper region, or increasing a wall thickness of the upper region thicker than a wall thickness of the portion below the upper region.

7. The manufacturing method of the aerosol can body having the surface pattern on the trunk portion as claimed in claim 5,
wherein an upper end portion of the inner tool is supported by a support rod falling from above the inner tool on which the can body is mounted to come into contact to the upper end portion of the inner tool though the opening curled portion.

8. The aerosol can body having the surface pattern on the trunk portion as claimed in claim 2,
wherein a buckling strength of the can body in which the bottom lid is attached to the lower opening is greater than 1700 N but less than 2500 N.

9. The aerosol can body having the surface pattern on the trunk portion as claimed in claim 3,
wherein a buckling strength of the can body in which the bottom lid is attached to the lower opening is greater than 1700 N but less than 2500 N.

10. The manufacturing method of the aerosol can body having the surface pattern on the trunk portion as claimed in claim 9,
wherein an upper end portion of the inner tool is supported by a support rod falling from above the inner tool on which the can body is mounted to come into contact to the upper end portion of the inner tool though the opening curled portion.
